(19) United States
(12) Patent Application Publication
(10) Pub. No.: US 2007/0118764 A1
(43) Pub. Date: May 24, 2007

(54) Optical disc, player for the optical disc and its play back method

(75) Inventors: Yang Peng, Shanghai (CN); Dahua He, Shanghai (CN); Declan Patrick Kelly, Eindhoven (NL); Philip Steven Newton, Eindhoven (NL); Sheng Jin, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/575,424

(22) PCT Filed: Oct. 12, 2004
(86) PCT No.: PCT/IB04/52053

§ 371 Date: Apr. 10, 2006

(30) Foreign Application Priority Data
Oct. 13, 2003 (CN) 200310101590.9

(51) Int. Cl. G06F 12/14

(52) U.S. Cl. 713/193

(57) ABSTRACT

An optical disk, optical disk player and optical disk playing method are disclosed, wherein the optical disk is used to play in coordination with the downloaded contents. The optical disk has a public key used to verify whether the downloaded content is authenticated. The optical disk player comprises a reading-out means, a network interface and a verifying module, in which the reading-out means is used to read-out the content and the public key of the optical disk; the network interface is used to receive the downloaded content; and the verifying module is used to verify whether the downloaded content is authenticated according to the public key read-out from the optical disk. The optical disk playing method consists of reading-out the content and the public key of the optical disk, downloading the content, then verifying the downloaded content according to the public key read-out from the optical disk, in order to confirm whether the downloaded content is authenticated.

### BACKGROUND OF THE INVENTION

The present invention relates to an optical disc, an optical disc player and method for playing an optical disc.

With the rapid development of optical disc and disc playing technology, more and more contents are stored in web severs, so as to be downloaded to the player during playing a disc thereby cooperate with the player for playing the disc.

The downloaded content may be applications, audio, advertisement, games, cartoon and caption. Wherein the applications are the applications in JAVA or other languages, and compared with other languages, applications in JAVA are more versatile for the platform independence of the language. JAVA applications can be used to control the playing of various players, and storing it on the web sever will provide various player manufacturers with broader business platforms, and provide user with more flexible applications.

The method of storing the above contents on a web sever and then downloading it to a player to cooperate with the player for playing disc is used in many discs and corresponding players, e.g. Blue-ray Disc and corresponding player, e-DVD (enhanced DVD) and corresponding player.

Presently, the scope of content downloadable from the web is determined by the URLs (Uniform Resource Locator) list (Walled Garden) stored on the disc. If the URLs corresponding to the downloaded content are not in the URLs list stored on the disc, executing of the downloaded content will be rejected.

However, the contents corresponding to the URLs list stored on the disc are only confirmed by the content provider to be providable to the users, that is, the contents are stored in the web sever directly without authentication. Authentication means that when the optical disc contents provider stores the content corresponding to the optical disc in a web server, the optical disc contents provider itself or other CA (Certificate Authority, e.g. Internet Explorer of Microsoft and Navigator of Netscape, etc.) confirm that the content is providable to the users and has been added with a Private key. Said Private key is a digital information no less than 500 bits.

If above contents stored on the web by disc content provider is not authenticated, the content could be easily modified by others (e.g. a hacker, pirate or advertising agency), with the URLs still corresponding to the URLs listed in the URLs list stored on the disc, thereby enabling the player to play the downloaded contents, which is quite possible to cause damage to the player and the contents on the disc, resulting in great trouble to the user.

It is also possible that the user inputs new URLs according to his need or the system pop-up unknown URLs (e.g. provided by a hacker, pirate and advertising agency) during playing. If these URLs are in accordance with the URLs list stored on the disc, thereby played by the player, same damage may also be resulted.

In addition, if the content provider or a third party authenticated by the content provider provide new entertainment contents to the user, and the URLs corresponding to the content is not in the URLs list stored on the disc, the player will still reject to play the downloaded content, even if the downloaded content is needed by the user, and will not cause damage to the disc, the player, or the contents of the disc. This will decrease the entertainment scope of the user, and limit the business modes of the content provider.

Accordingly, there exists a need for an improved optical disc, a player for playing the disc, and a method for playing the disc to avoid above defects.

### SUMMARY OF THE INVENTION

The present invention provides an optical disc with a Public Key.

The present invention further provides an optical disc player for playing an optical disc with a Public Key.

The present invention further provides a method for playing an optical disc with a Public Key.

The technical problem to be solved by the invention is achieved through the following technical scheme: said optical disc of the invention is used to cooperate with the downloaded content for playing. The optical disc has a Public Key that is used to confirm that the downloaded contents are authenticated.

The optical disc player of the invention comprises a read means, a web interface, and an authentication module. wherein the read means is used to read the contents and the Public Key; the web interface is used to receive the downloaded relative contents; and the authentication module is used to confirm that the downloaded contents are authenticated.

The method of the invention for playing a disc is to perform authentication to downloaded contents based on the read Public Key after reading out the content and the Public Key of an optical disc and downloaded the contents, so as to confirm that the downloaded contents are authenticated.

With this technical scheme of the invention, the optical disc, the optical disc player, and the playing method determine whether the downloaded content should be played by checking whether the downloaded contents are authenticated. Accordingly, no matter how the URLs change, the corresponding contents are playable as long as authenticated. When the downloaded contents are not authenticated, they will be rejected to play even when the corresponding URLs are in accordance with the URLs stored on the disc, thereby avoiding influence caused by playing information with virus, and also improve the interest of users' watching disc.

### BRIEF DESCRIPTION OF THE DRAWINGS

FIG. 1 is a schematic diagram illustrating the optical disc and the relationship between relevant elements according to an embodiment of the present invention;

FIG. 2 is a schematic diagram illustrating the structure of the disc of FIG. 1;

FIG. 3 is a schematic diagram illustrating the structure of the player of FIG. 1;

FIG. 4 is a flowchart of the method for playing the disc according to an embodiment of the present invention.

### Now the present invention will be described in more details with reference to the accompanied drawings.

### PREFERED EMBODIMENTS

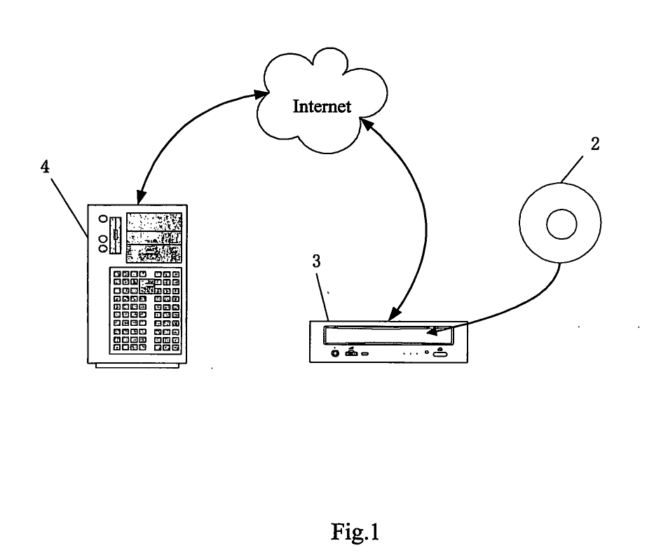

An embodiment of the present invention is shown in FIG. 1. In this embodiment, a player 3 is used to play an optical disc 2, and the player 3 is linked to a web server 4 to download contents from the web server 4 during playing, so as to cooperate with the existing content on the optical disc 2 to play the optical disc 2.

The downloaded contents may be applications, audio, advertisement, games, cartoon and caption. Wherein the applications are applications in JAVA or other languages, and compared with other languages, applications in JAVA are more versatile for the platform independence of the language. JAVA applications can be used to control the playing of various players, and storing it on the web sever will provide various player manufacturers with broader business platforms, and provide user with more flexible applications.

Moreover, the downloaded contents are all authenticated. That is, when the optical disc content provider stores the contents corresponding to the optical disc on a web server, the optical disc contents provider itself or other CA (Certificate Authority, e.g. Internet Explorer of Microsoft and Navigator of Netscape, etc.) confirm that the contents are providable to the users and has been added with a Private key. Said Private key is a digital information no less than 500 bits. Due to the presence of the Private key, the downloaded contents are not easy to be modified by others on the web.

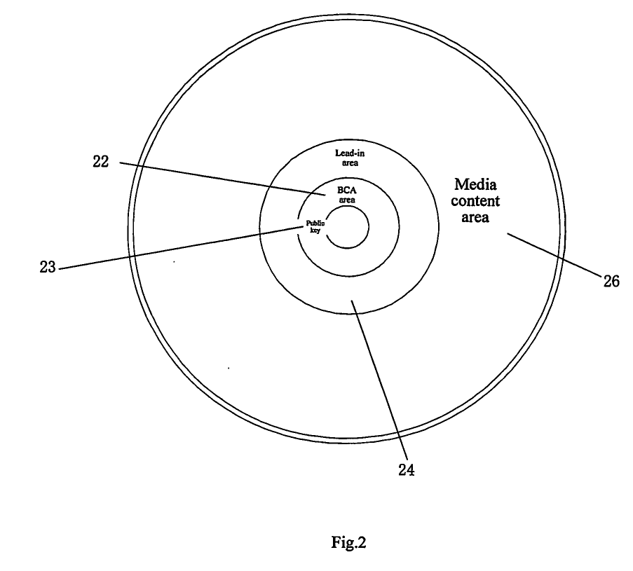

FIG. 2 is a schematic diagram illustrating the structure of the optical disc 2 in accordance with an embodiment of the present invention. The optical disc 2 comprises a BCAs (Burst Cutting Areas) 22, Lead-in Area 24 and Media Content Areas 26. Wherein the BCAs 22 includes a Public key 23, which is used to verify that the downloaded contents are authenticated when playing the optical disc 2. The BCAs 22 corresponds to the Private key of the downloaded contents, and is a digital information no less than 500 bit.

Wherein the authentication is carried out by the unsymmetrical algorithm, in which digital information is obtained through operation of the Private key of the downloaded contents and the Public key of the optical disc 2 (which will be described in detail hereinafter).

The Public key 23 shown in FIG. 2 is located in the BCAs 22 of optical disc 2, but it is only an example, and it may be located in other areas of the optical disc 2, e.g. the led-in Area 24 and Media Content Areas 26, etc. Moreover, only one Public key 23 is shown in FIG. 2, in fact, there may be a plurality of Public key 23 directed to different contents on the total optical disc 2. The Public key 23 of the optical disc 2 may also be used to be sent to the web server 4 to obtain the authority for playing the optical disc 2.

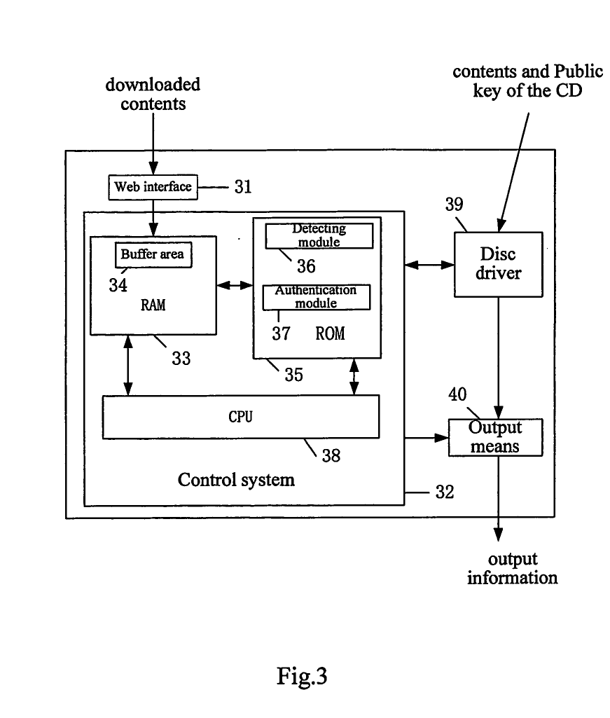

An optical disc player 3 according to an embodiment of the present invention is shown in FIG. 3. The optical disc player 3 comprises a web interface 31, a control system 32, a driver 39, and an output means 40.

Wherein, the control system 32 is used to control the operation of the disc driver 39 and the output means 40, and comprises RAM 33, ROM 35 and CPU 38. RAM 33 comprises a buffer area 34 for buffering downloaded contents transferred via the web interface 31. ROM 35 comprises a detecting module 36 and an authentication module 37. The ROM 35 is linked with RAM 33 to receive the downloaded contents from RAM 33.

CPU 38 is linked with RAM 33 and ROM 35, and controls the operation of RAM 33 and ROM 35. Under the control of the control system 32, the disc driver 39 reads the media content and Public Key 23 from disc 2, transfers the Public Key 32 to ROM 36 of the control system 32, and transfers the media contents to output means 40.

The detecting module 36 in the control system 32 is used to determine whether the downloaded contents transferred from the buffer 34 are integral. If not integral, then give up playing the downloaded contents. If it is integral, the authentication module 37 verifies that the downloaded contents are authenticated. The verification is carried out using currently perfect Public Key System Algorithm and protocols. For example, the verification result can be obtained by the operation relationship between the digital in the Private key of the downloaded contents and the digital in the Public Key from the disc driver 39. Take as a simple example, the relationship between the Public key 23 of the disc 2 and the Private key of the downloaded contents is Y=B^{X}, wherein the Public key 23 includes digital Y and B, and the Private key of the downloaded content s includes X. The authentication module 37 computes the result of B^{X}, and if the result is Y, the downloaded contents pass verification, and the downloaded contents are considered to be authenticated and can be played. If the result is not Y, the downloaded contents do not pass verification, and the player 3 will reject to play the downloaded contents. The output means is used to output the information read by the disc driver and the information output from the control system. The functions of the above elements are all implemented under the cooperation of CPU 34.

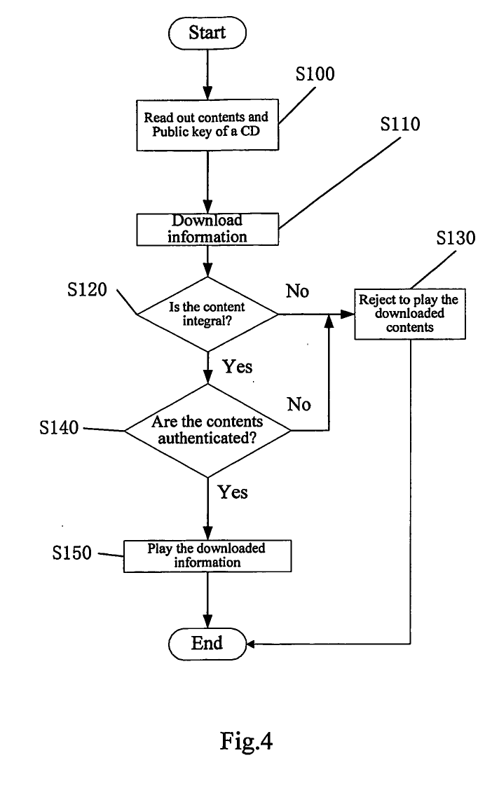

FIG. 4 is a flowchart of the method for playing an optical disc according to an embodiment of the present invention. After reading the contents and the public key of the disc (S100), the player 3 downloads the contents corresponding to the optical disc contents from web server (S110).

Next, the integrity of the downloaded contents is checked (S120) to determine whether the downloaded contents are integral. If the content is not integral, the downloaded content will be rejected to play (S130).

If the content is integral, the Public key 23 will be used to determine whether the downloaded contents are authenticated (S140). If not authenticated, the downloaded contents will be rejected to play (S130); if authenticated, the downloaded contents will be played directly (S150), thereby cooperating with the information stored on the disc 2 to play the disc 2.

With the technical scheme of the present invention, the optical disc, the player, and the method of playing the disc determine whether to play the downloaded contents by detecting whether the contents are authenticated. Therefore, no matter how URLs change, the downloaded contents can be played as long as they are authenticated. But if the downloaded contents are not authenticated, it will be rejected to play even if the URLs corresponding to the downloaded contents correspond to the URLs stored on the optical disc, thus, the influence caused by playing information with virus may be avoided, and the interest of users' watching disc is improved.

While the invention has been described with reference to certain preferred embodiments thereof, various alternatives, modifications and changes will be apparent to the skilled in the art. Therefore, the present invention will include the alternatives, modifications and changes without departing from the spirit and scope of the invention as defined by the appended claims.

1. An optical disk, used to play in coordination with the downloaded content, comprising a public key which is used to verify whether the downloaded content is authenticated.

2. The optical disk according to claim 1, wherein the public key being stored in the BCAs zone of the optical disk.

3. The optical disk according to claim 1, wherein the public key being stored in the media content zone of this laser disk.

4. An optical disk player, comprising:
a reading-out means for reading-out the content and the public key of the optical disk;
a network interface for receiving related downloaded content;
a verifying means for verifying whether the related downloaded content is authenticated according to the public key read-out from the optical disk.

5. The optical disk player according to claim 4, further comprising:
a detecting means for detecting the integrality of the downloaded content, said verification will not be executed if the detected content is not integral.

6. The optical disk player according to claim 4, wherein the downloaded content being an application program.

7. The optical disk player according to claim 6, wherein the downloaded application program being the JAVA language application program.

8. A playing method, comprising:
reading-out the content and the public key of an optical disk;
downloading the related content;
verifying whether the downloaded content is authenticated according to the public key read-out from the laser disk, in order to confirm whether the downloaded content will be operated.

9. The playing method according to claim 8, further comprising:
detecting the integrality of the downloaded content to confirm whether the downloaded content is integral, said verification step will not be executed if the content is not integral; said verification step will be executed if the detected content is integral.

10. The playing method according to claim 8, wherein the downloaded content will be refused to operate if the verified downloaded content is not authenticated.

11. The playing method according to claim 10, wherein the downloaded content will be operated if the verified downloaded content is authenticated.

12. The playing method according to claim 8, wherein the downloaded content being an application program.

13. The playing method according to claim 12, wherein the downloaded application program being the JAVA language application program.

14. An optical disk, used to play in coordination with the downloaded content, comprising a part used to verify whether the downloaded content is authenticated.

15. An optical disk, used to realize playing by being connected with the network server, comprising a part used to verify the playing permission of the optical disk in coordination with the network information.

16. The optical disk according to claim 15, wherein the part being the public key stored in the optical disk.
